(19) United States
(12) Patent Application Publication
(10) Pub. No.: US 2024/0382360 A1
(43) Pub. Date: Nov. 21, 2024

(54) ISOLATION ROOM APPARATUS

(71) Applicant: Care Strategic D.I.R. Holdings Pty. Ltd., Ninderry, Queensland (AU)

(72) Inventors: Justin Douglas Ballantyne, Ninderry, Queensland (AU); James Edward Robert Burkwood, Buderim, Queensland (AU); Anna Louise Ballantyne, Ninderry, Queensland (AU)

(21) Appl. No.: 18/704,370

(22) PCT Filed: Nov. 3, 2022
(86) PCT No.: PCT/AU2022/051320

§ 371 Date: Apr. 24, 2024

(30) Foreign Application Priority Data
Nov. 3, 2021 (AU) 2021903505

(51) Int. Cl. A61G 10/00; E04H 1/12

(52) U.S. Cl. CPC A61G 10/005; E04H 1/125

(57) ABSTRACT

An isolation room apparatus configured to isolate a subject, the apparatus including: a frame movable between collapsed and erected configurations, the frame including: first and second front frame members; first and second rear frame members; a canopy mounting mounted to each frame member, and, a curtain rail that in the erected configuration is mounted proximate upper ends of the first and second front frame members so that the curtain rail extends between the first and second front frame members above an opening defining a doorway; and, a canopy configured to be supported by the frame in the erected configuration, the canopy defining an internal volume for containing a subject to thereby substantially isolate the subject from a surrounding environment.

### BACKGROUND OF THE INVENTION

The present invention relates to an isolation room apparatus configured to isolate a subject, and in one particular example, to an isolation room apparatus configured to isolate a patient within a healthcare facility, such as a hospital ward, or the like.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Infection control in hospitals and other healthcare facilities is becoming increasingly important with the rise in incidences of infectious diseases, drug resistant infections, or the like. Such infections can have severe consequences, particularly in patients with an already compromised immune system, resulting in increased duration of hospital stays, increased treatment costs and increased mortality. Estimates indicate that in some healthcare institutions infection levels can be in the region of 10-20%, meaning infections acquired in medical facilities represent a significant proportion of annual healthcare expenditure.

Infections are typically transmitted through a number of different mechanisms, including contact transmission, droplet transmission and airborne transmission. Current best practice for reducing infection rates typically relies on basic hygiene measures, such as regular hand washing, surface sanitisation, and equipment sterilisation, to thereby prevent infection of other patients. However, the effectiveness of such measures is limited, and World Health Organisation standards indicate that patients with infections or suspected of having infections should be isolated from other patients. This can prove difficult with many facilities not having adequate resources and available space to separate infected patients.

A number of solutions have been proposed to address such issues.

EP-0,619,108 describes an enclosure for isolating a patient including an external frame and a flexible envelope suspended from and hanging within the frame. The envelope has a bottom, top, two sides, front and a rear wall portions. One of the side or front wall portions is fitted with a closable entry means allowing entry of the patient. There is an opening in one of the wall portions fitted with an integral filter means adapted to filter out infectious particles from the air and to cooperate with a pump means, and a valve means allowing uni-directional air passage from the outside to the inside of the enclosure. The pump means draws air through said filter means which creates a negative pressure inside the enclosure, whereby air flows in the direction valve-enclosure-filter means ensuring that no contaminating agents will escape from within the enclosure to the outside.

US2004074212 describes a patient isolation unit including a foldable frame body, a flexible envelope made of a flammable resin sheet which can be attached to the assembled frame body, and an exhauster to discharge or exhaust the air from the envelope. The exhauster includes a UV lamp, an HEPA (High-Efficiency Particulate Air) filter, and a blower.

However, these arrangements suffer from a number of drawbacks. For example, the need to maintain a hermetically sealed envelope makes the apparatus complex and hence expensive. The arrangements are also difficult to erect as well as requiring that the arrangement is erected with the patient being subsequently moved into the envelope, which can be inconvenient and which may prevent the arrangements being used in some circumstances. Finally, these arrangements typically require that the doors are opened manually, by hand, meaning infectious materials can be transferred onto the door when this is being opened, leading to subsequent onward transmission, and thereby limiting the effectiveness of the arrangements.

WO2014019022 describes an apparatus for use in isolating a subject, the apparatus including a frame movable between collapsed and erected configurations, a body supported by the frame, wherein in the erected configuration, the body defines an internal volume for containing a subject to thereby substantially isolate the subject from a surrounding environment and a door actuator supported by the frame for moving a door between open and closed positions to thereby provide access to the internal volume.

The frame of the above described arrangement needs to be elevated in order to raise a curtain rail and a canopy at a height sufficient to accommodate patients and medical personnel. This in turn adds to the overall weight and complexity of the frame, which can make the frame difficult to deploy, particularly if it is being deployed by a single person.

WO2018165715 describes an apparatus for use in providing isolation, the apparatus including an isolation tent having a body including a roof member, at least one wall extending between a supporting surface and the roof member in use to thereby at least partially define an internal volume substantially isolated from a surrounding environment, a plurality of connectors coupled to the body, the plurality of connectors being adapted to physically attach the body to a frame and an electrical component electrically connected to at least one of the plurality of connectors to allow electrical signals to be transferred to or from the electrical component via the connector.

### SUMMARY OF THE PRESENT INVENTION

In one broad form, an aspect of the present invention seeks to provide an isolation room apparatus configured to isolate a subject, the apparatus including: a frame movable between collapsed and erected configurations, the frame including: first and second front frame members; first and second rear frame members; deployable arms interconnecting: the first front and first rear frame members; the rear frame members; and, the second front and second rear frame members; a canopy mounting mounted to each frame member; and, a curtain rail that in the erected configuration is mounted proximate upper ends of the first and second front frame members so that the curtain rail extends between the first and second front frame members above an opening defining a doorway; and, a canopy configured to be supported by the frame in the erected configuration, the canopy defining an internal volume for containing a subject to thereby substantially isolate the subject from a surrounding environment and the canopy including one or more curtains supported by the rail to allow the curtains to be moved between open and closed positions to selectively provide access to the internal volume.

In one embodiment the front frame members and curtain rail are configured so that the curtain rail is supported without requiring elevation or extension of the front frame members.

In one embodiment the curtain rail is pivotally mounted proximate to an upper end of the first front frame member and configured to be mounted to an upper end of the second front frame member at a height sufficient to support the rail in an operative position.

In one embodiment the curtain rail is slidably mounted to the second front frame member, so that the curtain rail raises as the frame is moved from the collapsed to the erected configuration.

In one embodiment the curtain rail is configured to abut against the first front frame member when the frame is in the collapsed configuration.

In one embodiment the curtain rail is stored removably mounted to the first front frame member when the frame is in the collapsed configuration and when the frame is in the erected configuration, the curtain rail is removably attached proximate upper ends of the first and second frame members.

In one embodiment the curtain rail is extendible so that at least one of a width of the frame in the erected configuration is adjustable; and, a width of the doorway is adjustable.

In one embodiment the apparatus is configured to be used with different sized canopies to provide isolation rooms having different widths.

In one embodiment canopy mountings are at least one of movably mounted to each frame member, the canopy mountings being movable between lowered and elevated positions; slidably mounted to a surface of the front frame members; and, supported by a shaft that can be raised relative to a frame member.

In one embodiment canopy mountings are moved between lowered and elevated positions using linear actuators.

In one embodiment the frame includes: first and second anteroom frame members; and, an anteroom curtain rail that in the erected configuration is mounted proximate upper ends of the first and second anteroom frame members so that the curtain rail extends between the first and second anteroom frame members above an opening defining a anteroom doorway, and wherein the canopy is configured to define a first internal volume configured to contain the subject and a second internal volume configured to define an anteroom.

In one embodiment the frame includes: first and second anteroom frame members; and, extendable arms interconnecting: the first front and first anteroom frame members; the second front and second anteroom frame members; the first anteroom and first rear frame members; and, the second anteroom and second rear frame members; and, an anteroom curtain rail that in the erected configuration is mounted proximate upper ends of the first and second anteroom frame members so that the curtain rail extends between the first and second anteroom frame members above an opening defining a anteroom doorway, and wherein the canopy is configured to define a first internal volume between the rear and anteroom frame members for containing the subject and a second internal volume between the anteroom and front frame members defining an anteroom.

In one embodiment the apparatus includes one or more canopy rails that in the erected configuration extend between frame members to engage the canopy.

In one embodiment the one or more canopy rails support the canopy in an elevated position and extend between at least one of upper ends of the rear frame members; upper ends of the first front and first rear frame members; upper ends of the second front and second rear frame members; upper ends the first front and first anteroom frame members; upper ends the second front and second anteroom frame members; upper ends the first anteroom and first rear frame members; and, upper ends the second anteroom and second rear frame members.

In one embodiment the one or more canopy rails bias the canopy against a floor and extend between at least one of: lower ends of the rear frame members; lower ends of the first front and first rear frame members; lower ends of the second front and second rear frame members; lower ends the first front and first anteroom frame members; lower ends the second front and second anteroom frame members; lower ends the first anteroom and first rear frame members; and, lower ends the second anteroom and second rear frame members.

In one embodiment the deployable arms include the one or more canopy rails.

In one embodiment the apparatus includes: a filter; and, a fan configured to urge air into and/or out of the internal volume through the filter.

In one embodiment the canopy is configured to at least partially seal to a floor.

In one embodiment the apparatus includes an air pump configured to pump air out of the internal volume so that the internal volume is at least partially negatively pressurized.

In one embodiment the collapsed configuration the frame has a maximum height that is at least one of greater than 1400 mm; greater than 1500 mm; greater than 1600 mm; greater than 1750 mm; less than 2100 mm; less than 2000 mm; less than a standard doorway opening; and, about 1895 mm.

In one embodiment, without extension, the front frame members reach a height that is at least one of greater than 1400 mm; greater than 1500 mm; greater than 1600 mm; greater than 1750 mm; less than 2100 mm; less than 2000 mm; less than a standard doorway opening; and, about 1895 mm.

In one embodiment the apparatus includes a controller that is configured to control at least one of: extension of the curtain rail; extension of the extendable arms; operation of a filter fan; operation of an air pump.

In one embodiment the apparatus includes a sensor configured to sense a canopy size, and wherein the controller is configured to control extension of the curtain rail and one or more extendable arms in accordance with a sensed canopy size.

In one embodiment the canopy includes coded data indicative of the canopy size and the sensor is configured to sense the coded data provided on the canopy.

In one embodiment the frame may be detacheably coupled to an anteroom frame, wherein the anteroom frame includes: a frame movable between collapsed and erected configurations, the frame including: first and second front anteroom frame members; first and second rear anteroom frame members; deployable anns interconnecting: the first front and first rear anteroom frame members; the rear anteroom frame members; and, the second front and second rear anteroom frame members; an anteroom canopy mounting mounted to each anteroom frame member; and, an anteroom curtain rail that in the erected configuration is mounted proximate upper ends of the first and second anteroom front frame members so that the curtain rail extends between the first and second front anteroom frame members above an opening defining a doorway; and, an anteroom canopy configured to be supported by the anteroom frame in the erected configuration, the anteroom canopy defining an internal volume.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:—

FIG. 1A is a schematic perspective view of an example of a frame for an isolation room apparatus in a collapsed configuration;

FIG. 1B is a schematic perspective view of the frame of FIG. 1A in an erected configuration;

FIG. 2A is a schematic plan view of the frame of FIG. 1A in the collapsed configuration;

FIG. 2B is a schematic front view of the frame of FIG. 1A in the collapsed configuration;

FIG. 2C is a schematic right side view of the frame of FIG. 1A in the collapsed configuration;

FIG. 2D is a schematic plan view of the frame of FIG. 1A in the erected configuration;

FIG. 2E is a schematic front view of the frame of FIG. 1A in the erected configuration;

FIG. 2F is a schematic side view of the frame of FIG. 1A in the erected configuration;

FIGS. 3A to 3F are schematic diagrams illustrating an example of the process of erecting an isolation room apparatus including the frame of FIG. 1A;

FIG. 4A is a schematic left side view of a further example of a frame for an isolation room apparatus in a collapsed configuration;

FIG. 4B is a schematic left side view of the frame of FIG. 4A a first erected configuration;

FIG. 4C is a schematic left side view of the frame of FIG. 4A a second erected configuration;

FIG. 5A is a schematic left side view of a further example of a frame for an isolation room apparatus in a collapsed configuration;

FIG. 5B is a schematic left side view of the frame of FIG. 5A a first erected configuration;

FIG. 5C is a schematic left side view of the frame of FIG. 5A a second erected configuration;

FIG. 6A is a schematic left side view of a further example of a frame for an isolation room apparatus in a collapsed configuration;

FIG. 6B is a schematic left side view of the frame of FIG. 6A a first erected configuration;

FIG. 6C is a schematic left side view of the frame of FIG. 6A a second erected configuration;

FIG. 6D is a schematic left side view of the frame of FIG. 6A the second erected configuration with canopy rails deployed;

FIG. 7 is a schematic front view of a further example of a frame in the erected configuration;

FIG. 8 is a schematic front view of a further example of a frame in the erected configuration;

FIG. 9A is a schematic left side view of a further example of a frame for an isolation room apparatus in a collapsed configuration;

FIG. 9B is a schematic left side view of a frame for an anteroom room in a collapsed configuration;

FIG. 9C is a schematic left side view of the frame of FIG. 9A in an erected configuration;

FIG. 9D is a schematic left side view of the frame of FIG. 9B in an erected configuration;

FIG. 9E is a schematic left side view of the frame of FIG. 9A and the frame of FIG. 9B in an erected configuration; and,

FIG. 9F is a schematic left side view of the frame of FIG. 9A and the frame of FIG. 9B coupled together in an erected configuration.

### DETAILED DESCRIPTION OF THE PREFERRED EMBODIMENTS

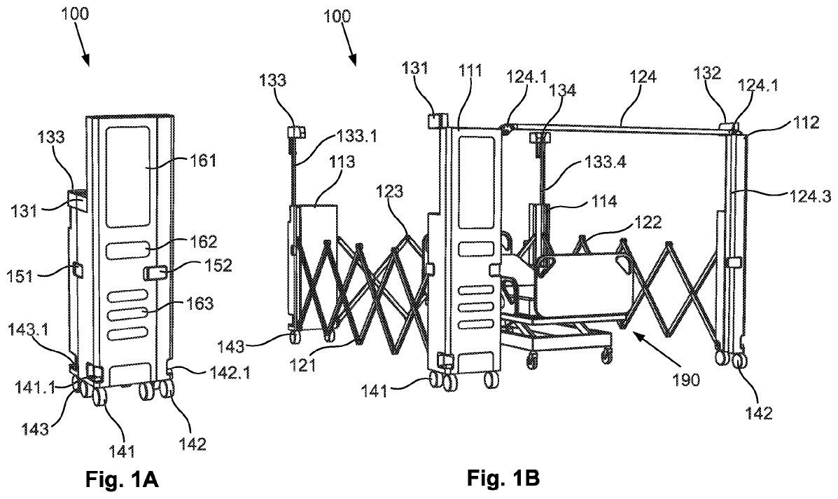

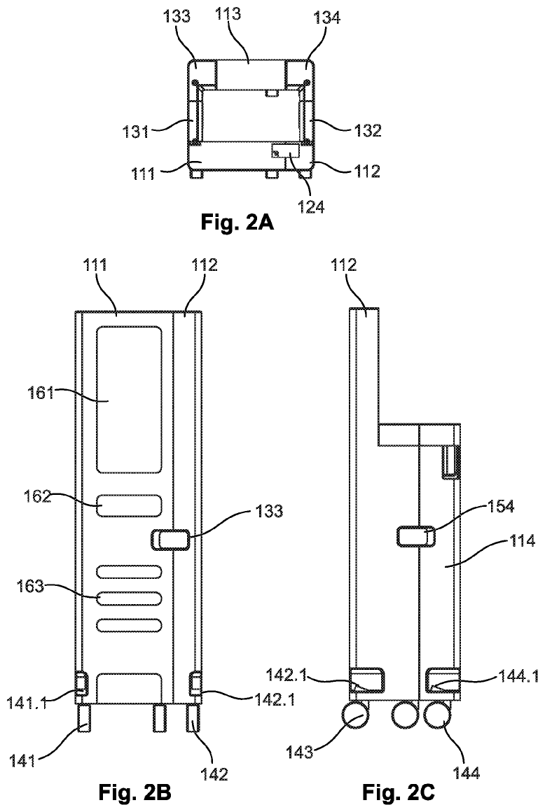

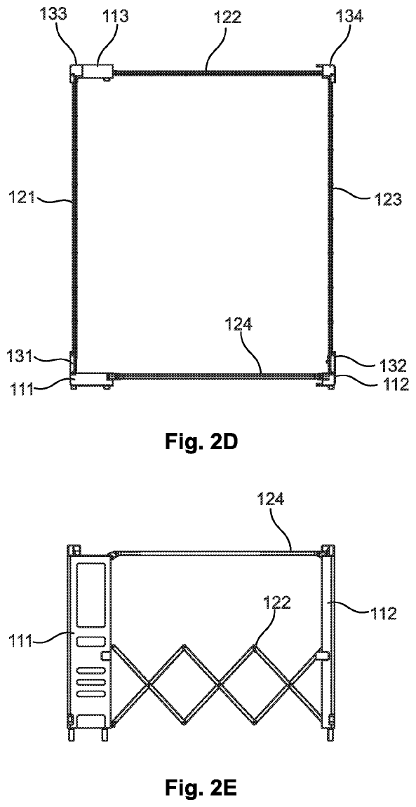

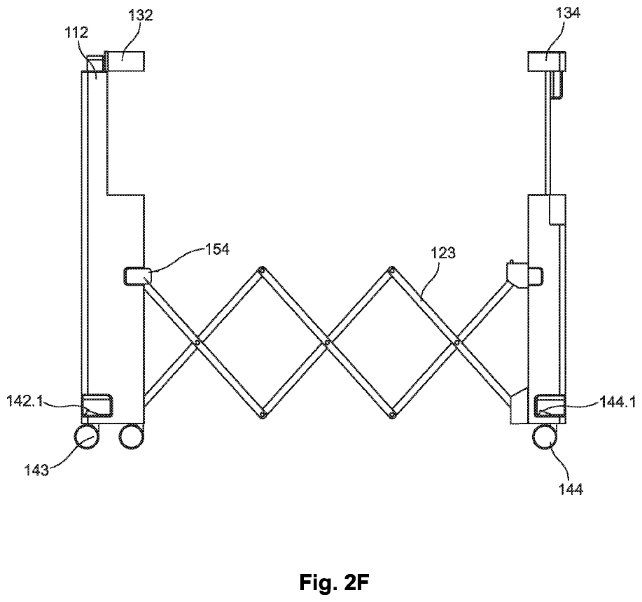

An example of an isolation room apparatus for use in isolating a subject, such as a patient, will now be described with reference to FIGS. 1A and 1B, and with further reference to FIGS. 2A to 2E.

In this example, the apparatus includes a frame 100, which in use is movable between collapsed and erected configurations, shown in FIGS. 1A and 1B, respectively. A canopy (not shown) can be supported by the frame 100, so that when the frame 100 is in the erected configuration, the canopy defines an internal volume for containing a subject, such as a patient on a bed 190, to thereby substantially isolate the subject from a surrounding environment, such as a hospital ward or similar.

The use of a collapsible frame 100 allows the apparatus to be provided in an operative configuration, shown in FIGS. 1B, with the frame 100 erected and a canopy attached (not shown), when it is required to isolate a subject. However, the frame 100 can also be provided in a storage configuration shown in FIG. 1A, in which the frame 100 is collapsed, when isolation of a subject is not required. This allows the apparatus to be conveniently stored and rapidly erected when required.

Furthermore, the use of wheels 141, 142, 142, 144, or similar, allows the frame to function as a trolley when not in use as an isolation room. For example, the trolley can include openings 161, 162, 163 or positions that can support items, such as medical or PPE (Personal Protective Equipment), including but not limited to masks, gloves, overalls, gowns, aprons, and/or cleaning and disinfection supplies such as disinfectant, sanitiser, hand or equipment steriliser, wipes, an air conditioning unit, a controller, such as a controller including a touchscreen monitor for displaying patient and device information, air filtration systems, controller or the like. The trolley can include a surface or an opening to store or display information about the subject or the like. Thus, it will be appreciated that reference to items that can be carried or stored is intended to be construed broadly, and reference to medical items and/or PPE is not intended to be limiting. Additionally, this allows the frame to be more easily moved into a location where the isolation room is required.

Accordingly, in one example, the apparatus can function either to isolate a subject, or as an infection control, PPE (Personal Protective Equipment) trolley, equipment trolley, or other suitable trolley. By providing a dual use configuration, this allows the apparatus to be provided on a ward, functioning as a trolley so that the apparatus does not take up unnecessary storage room. In the event that a patient is discovered to be infectious or is suspected of being infectious, the apparatus can be quickly erected around the patient, as will be described in more detail below. Thus, it will be appreciated from this, that the apparatus can be retained on a ward as an accessible equipment trolley whilst not being used, or used to isolate a patient whilst in the operative configuration. Even in the operative configuration, equipment and other items provided on the equipment trolley are still accessible, meaning the storage functionality provided by the apparatus is not impacted even while the apparatus is in the operative configuration.

The use of a suitable canopy can allow a sufficient degree of isolation to be provided to significantly reduce infection rates. For example, whilst the apparatus could be hermetically sealed, this is not essential, and more typically the apparatus is designed merely to help provide a barrier to contamination by at least one of solid, contact, fluid and droplet-borne contaminants. As part of this, a lower edge of the canopy may be adapted to engage a surface, such as a floor, on which the apparatus is arranged, thereby preventing contaminants passing between the canopy and the floor. This could be achieved using a variety of techniques, such as through the use of an adhesive arrangement, a weighted arrangement, a beam, a canopy rail, or similar, as will be described in more detail below.

Additionally, the apparatus acts as a warning to individuals that the isolated subject is infectious or suspected of being infectious, thereby serving to remind individuals regarding hygiene requirements, such as hand washing and the like, which further helps protect against contact transmission. Thus, even without hermetic sealing, the apparatus operates to significantly reduce the opportunity for infection, for example through contact or droplet transmission.

The above arrangement allows the canopy to be formed of a suitable flexible sheet material, such as a water resistant fabric, plastic sheeting, or the like, meaning the canopy can be lightweight and cheaply manufactured, and allowing the canopy to be disposed of following use. The use of a disposable canopy can further help reduce incidences of infection, although it will be appreciated that re-usable canopies could also be used.

Accordingly, the above described arrangement provides an apparatus for isolating a subject within an environment, such as a medical facility, hospital ward, or the like. It will be appreciated that this is broadly similar to the arrangements described in WO2014019022 and WO2018165715, the contents of which are incorporated herein by cross reference.

In the current example, the frame includes first and second front frame members 111, 112 and first and second rear frame members 113, 114, with deployable arms 121, 122, 123 interconnecting the first front and first rear frame members 111, 113, the rear frame members 113, 114, and the second front and second rear frame members 114, 112, respectively. In this example, the frame members 111, 112, 113, 114 could be made of a moulded polymer body optionally containing one or more structural elements, such as metal struts, or the like, although this is not essential and other arrangements could be used, such as sheet metal and extrusions. In this example, the deployable arms 121, 122, 123, are in the form of scissor arms, attached at each end to a respective frame member 111, 112, 113, 114, although this is not essential and other arrangements could be used, as will be described in more detail below.

The frame 100 includes canopy mountings 131, 132, 133, 134, movably mounted to each frame member 111, 112, 113, 114, with the canopy mountings being movable between lowered and elevated positions. In the lowered positions, this allows a canopy to be easily attached to the canopy mountings, whilst in the raised position, the canopy is suspended at a height sufficient to provide head clearance for most individuals within the internal volume. In this regard, it will be noted that the canopy mountings can be configured to be raised to a height above that of other components, such as the front frame members 111, 112, thereby ensuring adequate head clearance is provided within the internal volume.

The frame 100 further includes a curtain rail 124 that in the erected configuration is mounted proximate upper ends of the first and second front frame members 111, 112 so that the curtain rail extends between the first and second front frame members above an opening defining a doorway. In use, the canopy includes one or more curtains supported by the rail 124 to allow the curtains to be moved between open and closed positions to selectively provide access to the internal volume. In this regard, it will be noted that the term curtain is intended to encompass any member that can act to close a doorway, and whilst a membrane or fabric type material is more typical, the curtains could include vertical shutters, doors, partitions, or the like.

The front upright frame members 111, 112 and/or curtain rail 124 are configured so that the curtain rail is supported without requiring elevation or extension of the front upright frame members.

In the current example, this is achieved by having front frame members 111, 112 reach a height that allows the curtain rail to be supported so that it is suitable for use as a doorway. Nevertheless the front frame members 111, 112 are typically sized to be low enough to allow the frame to be wheeled through a normal internal doorway within a building. In this example, the front frame members do not need to extend or retract, and are similarly not lowered or raised, when the frame is moved between the collapsed and erected configurations. Thus, the frame can be easily moved around within a facility such as a hospital, wheeling this through doorways in the collapsed configuration, and then erected with the curtain rail being supported at a height suitable for forming a doorway.

To achieve this, the front frame members typically have a height close to that of a traditional doorway, and may for example have a height that is greater than 1750 mm, greater than 1800 mm, greater than 1850 mm, less than 2100 mm, less than 2040 mm, less than 2000 mm, less than a standard doorway opening, and in one particular example, about 1895 mm or 2000 mm.

However, other arrangements are possible. For example and as depicted in FIG. 7, the frame could include lower height front panel members 711, 712, and include a curved or U-shaped curtain rail 724, so that at least part of the curtain rail is higher than a top of the front panels 711, 712. In this example, the front panels may be lower, and could for example reach a height that is greater than 1400 mm, greater than 1500 mm, or greater than 1600 mm.

For similar reasons, in the collapsed configuration the frame has a maximum height that is greater than 1400 mm, greater than 1500 mm, greater than 1600 mm, greater than 1750 mm, less than 2100 mm, less than 2000 mm, less than a standard doorway opening, about 1895 mm.

Accordingly, in the above example, it is not necessary to raise the canopy and curtain rail in conjunction as described in WO2014019022. In the above example, the curtain rail does not need to be raised, reducing the overall weight that needs to be elevated at any one time, in turn making the isolation room easier to deploy and allowing the overall structure to be more lightweight. Thus, avoiding the need to elevate a part of the front frame member that supports the curtain rail, reduces the weight that needs to be lifted in order to erect the isolation room. This also removes the need for counterbalanced lifting arrangements. This makes the isolation room easier to erect, and also reduces the need for additional strengthening components, making the frame smaller and more lightweight in both erected and collapsed positions, which in turn makes the trolley configuration of the frame easier to manoeuvre. Additionally, this reduces the overall number and/or size and strength of components used to manufacture the frame, making the frame significantly cheaper. However, in other arrangements, the curtain may be wholly or partially elevated, with this being performed independently of raising of the canopy, thereby allowing the above mentioned benefits to be achieved even though the canopy and curtain rail are both raised.

As will be described in more detail below, whilst the rear frame members 113, 114 may be lower than the front frame members 111, 112, this is not essential, and rear frame members having a similar height to the front frame members may also be used.

A number of further features will now be described.

In the current example, the curtain rail 124 is pivotally mounted proximate to an upper end of the first front frame member 111, via a pivotal mounting 124.1. Furthermore, the curtain rail 124 is configured be mounted to an upper end of the second front frame member 112 at a height sufficient to support the rail in an operative position. In one example, the curtain rail 124 is slidably mounted to the second front frame member 112, for example, using a sliding mounting 124.2, which slides within a channel 124.3 in the second front frame member 112, so that the curtain rail raises as the frame is moved from the collapsed to the erected configuration, as will be described in more detail below. In this arrangement, the curtain rail 124 can be configured to abut against the first front frame member 111 when the frame is in the collapsed configuration and/or may be recessed within a cavity or channel in the first front frame member 111, or frame member 112.

It will be appreciated however, that other arrangements could be used. For example, the curtain rail could be removably mounted to the frame. For example, the curtain rail 124 could be stored removably attached to the first frame member 111 when the frame 100 is in the collapsed configuration and when the frame 100 is in the erected configuration, the curtain rail 124 could be removably attached proximate upper ends of the first and second frame members 111, 112. In this instance, it will be appreciated that although the curtain rail needs to be manually elevated for attachment to the front frame members, this step could be performed independently of lifting of the canopy or other parts of the frame, reducing the weight required to lift at any one time, and also reducing the weight needing to be lifted with other frame parts, hence reducing the required frame strength and hence weight, as described above.

In one example, the curtain rail is extendible, for example using a telescoping arrangement, so that a width of the frame 100 and/or a width of the doorway in the erected configuration is adjustable. In one example, different lengths of extension could be used in conjunction with different sized canopies to provide isolation rooms having different widths, in turn allowing the isolation room to be adapted for different scenarios. For example, if there is limited space within a facility, a narrower isolation room configuration could be used, whereas if a patient is likely to require attention from multiple individuals, a wider isolation room could be used. It will be appreciated that other arrangements could be used, such as a hinged rail, as described for example in WO2014019022. It will also be appreciated that a wider doorway can be created than would be achievable beyond the storage length of curtain rail limit set by the trolley height.

Extension of the curtain rail could be performed manually, and might include a locking arrangement, allowing different lengths of rail to be manually selected. Alternatively, this could be electronically controlled, using a linear actuator or similar, allowing a width of the frame to be controlled by a controller. Alternatively a combination of manual and automated approaches could be used, with the rail being manually extended, and locked into position using controlled solenoids, or similar.

In one example, front canopy mountings 131, 132 are slidably mounted to a surface, such as a rear surface, of the front frame members 111, 112. This allows the front canopy mountings 131, 132 to be easily supported and raised. In contrast, in the current example, the rear mountings 133, 134 are supported on shafts 133.1, 134.1, that are slidably mounted within the first and second rear frame members 113, 114. In each case, the canopy mountings could be moved between lowered and elevated positions using a variety of mechanisms. For example, this could be achieved by having a user physical raise the mountings, or could be performed using linear actuators, or similar, allowing the mountings 131, 132, 133, 134 to be raised electronically.

However, it will be appreciated that other arrangements could be used, such as using shafts to support the front canopy mountings. In this regard, it will be appreciated that canopy mountings could be provided that are movably independently. In this example, the curtain rail could be raised, for example, by raising a part of the front frame members. In this instance, raising the canopy and curtain rail independently, as opposed to in conjunction as described in WO2014019022, reduces the overall weight that needs to be elevated at any one time, in turn making the isolation room easier to deploy and allowing the overall structure to be more lightweight.

In order to provide protection against airborne transmission or aerosolised droplets, it is typical to provide an air filtering system, for example, using a HEPA filter, to thereby filter air extracted from the internal volume. Thus, the apparatus can include a filter and a fan configured to urge air into and/or out of the internal volume through the filter. This is also useful, for example, to provide airflow for patient comfort, whilst reducing the spread of aerosolised droplets. Whilst this could be achieved in any suitable manner, the filter could be provided as part of the canopy, with the fan being mounted on the frame, for example in the first rear frame member 113. In this regard, the rear frame member 113 can include a housing containing the fan and a drive unit and associated controller, and hence may be of a greater width than the second rear frame member 114, as shown in the drawings. In another example, the fan may be mounted in any of the other frame members 111, 112, or 114.

The canopy can be configured to at least partially seal to a floor, for example, using an adhesive or other arrangements, as will be described in more detail below. This can be used to allow a negative pressure to be created in the internal volume, which in turn can help prevent the spread of airborne infection beyond the internal volume. It will be appreciated that a negative pressure can be maintained even if the internal volume is not hermetically sealed, by provided sufficient sealing and continuous pumping of air from within the internal volume. Whilst the negative pressure could be generated using a fan, in another example, an air pump can be provided that is configured to pump air out of the internal volume to ensuring a sufficient rate of extraction of air from the internal volume.

In one example, the apparatus includes a controller that is configured to control one or more functional components, for example to control extension of the curtain rail, extension of the extendable arms, operation of a filter fan or operation of an air pump. The controller can be of any appropriate form, but typically includes an electronic processing device such as a microprocessor, microchip processor, logic gate configuration, firmware optionally associated with implementing logic such as an FPGA (Field Programmable Gate Array), or any other electronic device, system or arrangement. The controller can be incorporated into one or more of the frame members, such as the first front or rear frame members 111, 113, depending on the preferred implementation.

In one example, the controller is configured to determine a canopy size, with the controller being configured to control extension of the curtain rail and one or more extendable arms in accordance with the determined canopy size. The canopy size could be determined in any suitable manner, and this could include having a user enter the canopy size manually, for example using a user interface. Alternatively, the apparatus could include a sensor configured to sense a canopy size. This could be achieved using any suitable arrangement, such as by sensing a machine readable code printed on or otherwise presented on the isolation tent canopy, for example using visual marking, a remote readable data store, such as an RFID tag, or the like. The coded data can be read by the sensor, which could be a scanner or other suitable imaging device, wireless RFID tag reader, or wired ID tag or the like, so that the coded data can be read when the canopy is connected to the frame, allowing the controller to determine the canopy size and control opening of the frame accordingly.

The frame members 111, 112, 113, 114 can include latches 151, 152, 153, 154, which span between and engage the frame members 111, 112, 113, 114 when the frame is collapsed, thereby holding the frame in the collapsed configuration. In this example, a user can release the latches the 151, 152, 153, 154 when the frame is to be moved into the erected configuration, thereby releasing the frame members 111, 112, 113, 114 and allowing the frame to be expanded. This might also be achieved by automated electrically controlled latching mechanisms, such as solenoids, or the like.

As mentioned above, the frame can include one or more wheels 141, 142, 143, 144, such as caster wheels, mounted on each of the frame members 111, 112, 113, 114, allowing the trolley configuration of the frame to be easily moved and also to allow relative movement of the frame members 111, 112, 113, 114 during erection of the frame 100. In addition to this, each wheel or group of wheels 141, 142, 143, 144 can be associated with a respective locking mechanism, which in this example is in the form of a foot pedal 141.1, 142.1, 143.1, 144.1 configured to selectively engage and thereby lock the wheels. The foot pedals 141.1, 142.1, 143.1, 144.1 can be located in recesses in a lower edge of the frame members 111, 112, 113, 114, as shown, although other arrangements, such as mounting the foot pedals on the wheels directly, could be used. This might also be achieved by automated electrically controlled locking mechanisms, such as solenoids, or the like.

The apparatus 100 may also include a door actuator (not shown) supported by, and in particular mounted either to, or within, the frame 100, allowing curtains of the canopy to be opened or closed. In this example, when the curtains are closed, this closes the internal volume, whilst when the curtains are open position this provides access to the internal volume, thereby allowing users, such as medical practitioners to access the subject when required, while isolating the subject at other times. Furthermore, use of a suitable door actuator can allow ingress and egress without a user being required to touch the canopy, which can further assist in reducing spreading of infectious materials.

The curtains can be moveably mounted to the rail 124, with the actuator including foot pedals 124.4 coupled to the curtains via a cable or the like. This can provide a foot pedal system allowing hands free operation of the curtain door, enabling users to open and close the door without having to touch the door. However, it will be appreciated that other actuator arrangements could be used. In one particular example, this is achieved using an electric motor supported by the frame and coupled to at least one of an actuator switch or sensor. In further examples, sensors may be adapted to detect an identity of individuals attempting to open the door, for example by using an RFID (Radio Frequency identity) sensor and an associated tag worn by the individual. This can then be used to record an identity of individuals entering or exiting, which can be used for example in infection tracking, or to only allow access to authorised personnel, as will be appreciated by persons skilled in the art.

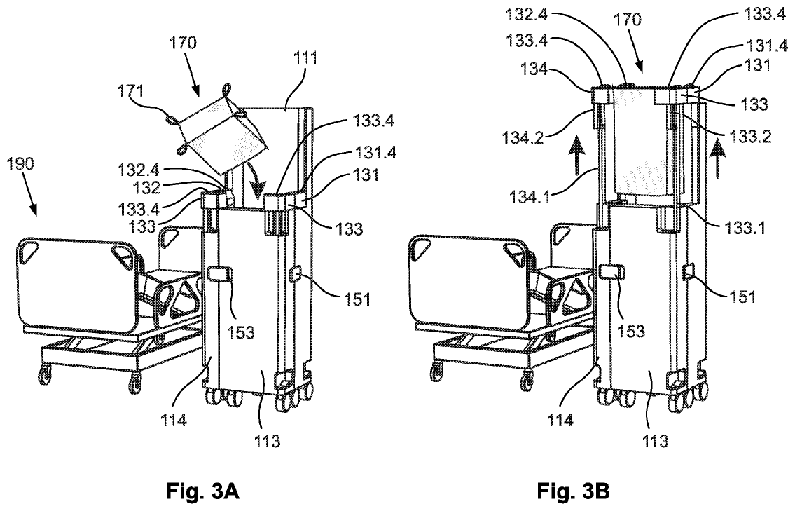

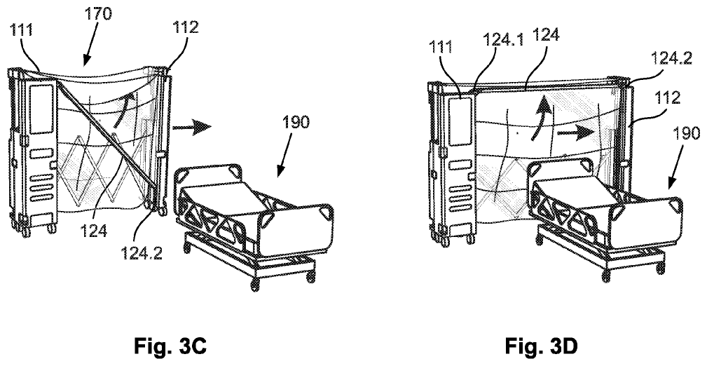

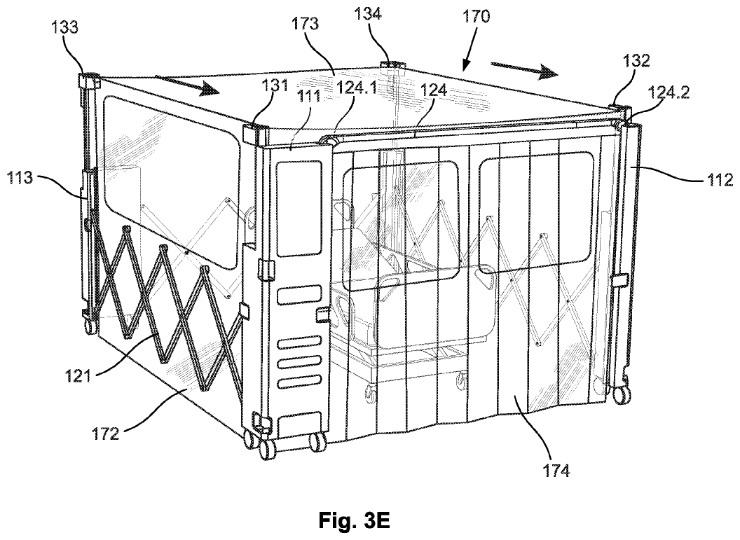

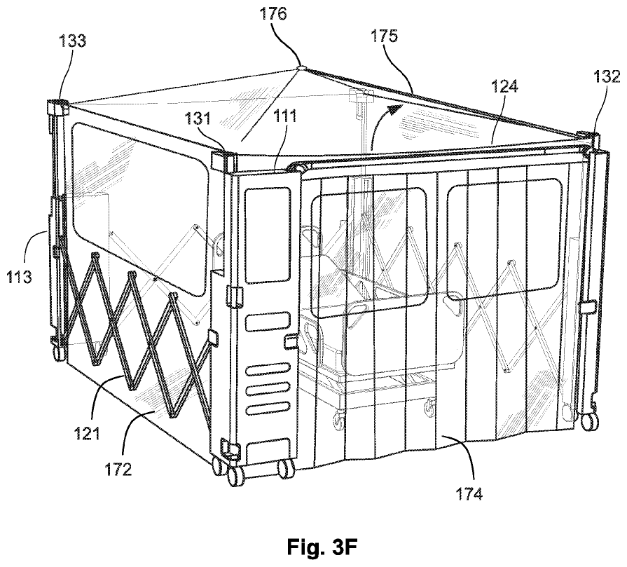

An example of a process for erecting the isolation room apparatus will now be described with reference to FIGS. 3A to 3F.

In this example, it is assumed the frame is the frame of FIGS. 1A, 1B and 2A to 2E. However, it will be appreciated that a similar process could be employed with the other frames described herein.

In this example, the frame 100 is initially provided in the trolley configuration, and positioned proximate a bed (optionally containing a patient) that is to be provided in the isolation room. A canopy is initially loaded into the frame, by inserting a folded canopy 170 into an opening between the frame members 111, 112, 113, 114, with connectors 171 of the canopy being attached to the canopy mountings 131, 132, 133, 134. The manner in which this is achieved will depending on the nature of the connectors 171 and the canopy mountings 131, 132, 133, 134, and could include positioning loops of material over upstanding pegs on the canopy mountings, using clip fit connectors, or the like.

To allow the user to easily connect and raise the canopy, the connectors 171 may be attached to the canopy mountings 131, 132, 133, 134 at a lowered height relative to the front frame member 111 as shown in FIG. 3A. The lowered height of the attachment of the canopy ensures persons of varying height may undertake this step without difficulty.

Once this is completed, the canopy mountings 131, 132, 133, 134 can be raised, as shown in FIG. 3B, thereby lifting the canopy to a suitable height, such as up above the level of the rear frame members 113, 114, or to a height at which it can be deployed. Lifting of the canopy mountings 131, 132, 133, 134 can be performed manually, for example releasing the mountings, and lifting these using handles 133.2, 134.2 on an underside of the rear canopy mountings 133, 134. At this stage, the canopy mountings 131, 132, 133, 134 can be in abutment, and may be connected using plug/socket arrangements, interlocks such as retractable or magnetic connectors, on adjacent mountings, so that the mountings are all lifted collectively. It will also be appreciated that the canopy mountings 131, 132, 133, 134 could be raised using linear actuators, optionally under control of the controller, for example by providing user input commands via a suitable user interface.

Next, the latches 152, 153 are released, allowing the rear frame members 113, 114 and the front frame members 111, 112 to be disengaged and moved apart. This is typically performed so that the frame extends behind the bed 190, as shown, allowing the canopy 170 to unfold behind the bed 190, as shown.

During this process, the curtain rail 124 will begin to be deployed, with the rail typically optionally partially extending and with the sliding mounting 124.2 at least partially sliding upwardly in the channel 124.3. As the extension process continues, upward pressure is typically provided on the rail 124, so that the rail 124 helps urge the front frame members 111, 112 apart, until the sliding mounting 124.2 reaches a top of the channel 124.3 and is locked into position, for example using a latch, or other similar locking mechanism. At this point, the rail may also be further extended if required, depending on the width of the installed canopy.

Following this, the latches 151, 154 are released, allowing the first front and rear frame members 111, 113 and the second front and rear frame members 112, 114 to be released, so that the front frame members 111, 112 can be moved forward, to thereby fully deploy the canopy, as shown in FIG. 3E, with the sidewalls 172, rear wall (not shown), roof 173 and curtains 174 defining the internal volume containing the bed 190.

In a further embodiment depicted in FIG. 3F, the apparatus may include a ceiling support arm 175 that swings or pivots up from the canopy mounting 132 at an angle from the frame 100 on the underside of the canopy. The ceiling roof support may be stowed in a position parallel to the curtain rail 124 when the frame 100 is in the trolley configuration. The canopy may be connected to the ceiling roof support 175 with a clip or magnetic connector 176 such that the angle of the ceiling support arm 175 elevates the height of the ceiling of the canopy.

In some examples, an anteroom may also be provided adjacent the doorway, to provide further sealing, as well as to provide a location in which contaminated materials, such as clothing or the like, can be removed and retained. In an anteroom version, the frame can include first and second anteroom frame members and an anteroom curtain rail that in the erected configuration is mounted proximate upper ends of the first and second anteroom frame members so that the curtain rail extends between the first and second anteroom frame members above an opening defining an anteroom doorway. Thus, in this arrangement, the canopy defines a first internal volume configured to contain the subject and a second internal volume configured to define an anteroom, with curtained doorways provided access to the anteroom and from there to the internal volume. Additionally the anteroom might be provided in a separate structure with a separate canopy that can be positioned adjacent to the entry of the canopy and may optionally be attached via connections between the bodies, the frames or any combination of the same.

Whilst the doorway of the isolation room frame may be adjacent the foot of the bed, it is also envisaged the doorway may be located on the side of the isolation room frame adjacent the long side of the bed. In this example, the anteroom may be provided adjacent the doorway on the same side as the long side of the bed. The curtain doorway to the anteroom, may also be on the long side, or alternatively on the short side of the anteroom frame.

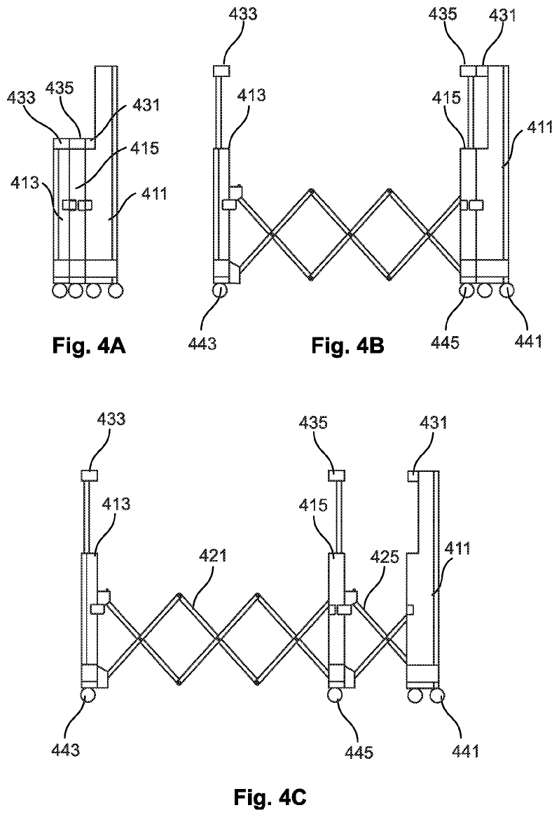

A specific example arrangement will now be described with reference to FIGS. 4A to 4C. In this example, similar features are denoted by similar reference numerals increased by 300 and these will not therefore be described in any detail.

In this example, the frame 400 includes a first anteroom frame member 415 and a second anteroom frame member (not shown in these side views). Extendable anns are provided, including first arms 425 interconnecting the first front and first anteroom frame members 411, 415 and similar second arms (not shown in these side views) interconnecting the second front and second anteroom frame members. First anns 421 are provided interconnecting the first anteroom and first rear frame members 415, 413, with similar second arms (not shown in these side views) interconnecting the second anteroom and second rear frame members. Wheels 441, 443, 445 are provided on the first front, rear and anteroom frame members 411, 413, 415, with equivalent arrangements being on the second front, rear and anteroom frame members. Low friction glides or other similar mechanisms might be used as an alternative to the wheels, whilst the anteroom frame members could be supported by the scissor arms.

In this example, the first and second arms connecting the rear and anteroom frame members can be extended to provide a single internal volume, as shown in FIG. 4B. Otherwise, the first and second arms interconnecting the anteroom and front frame members can also be extended, providing the additional anteroom, as shown in FIG. 4C.

An anteroom curtain rail (not shown), is provided, which in the erected configuration is mounted proximate upper ends of the first and second anteroom frame members so that the curtain rail extends between the first and second anteroom frame members above an opening defining a anteroom doorway. It will be appreciated that this is generally similar to the curtain rail 124 described above extending between the first and second front frame members, and that an equivalent rail would also be provided in this example. Consequently, a canopy when connected defines a first internal volume between the rear and anteroom frame members for containing the subject and a second internal volume between the anteroom and front frame members defining an anteroom.

Thus, in this instance, the additional anteroom frame members are provided between the front and rear frame members, although it will be appreciated that the anteroom frame members could alternatively be provided forwardly of the front frame members.

In the example, of FIGS. 4A to 4C, the anteroom frame members are generally of a similar form to the rear frame members. However, this is not essential and other arrangements could be used.

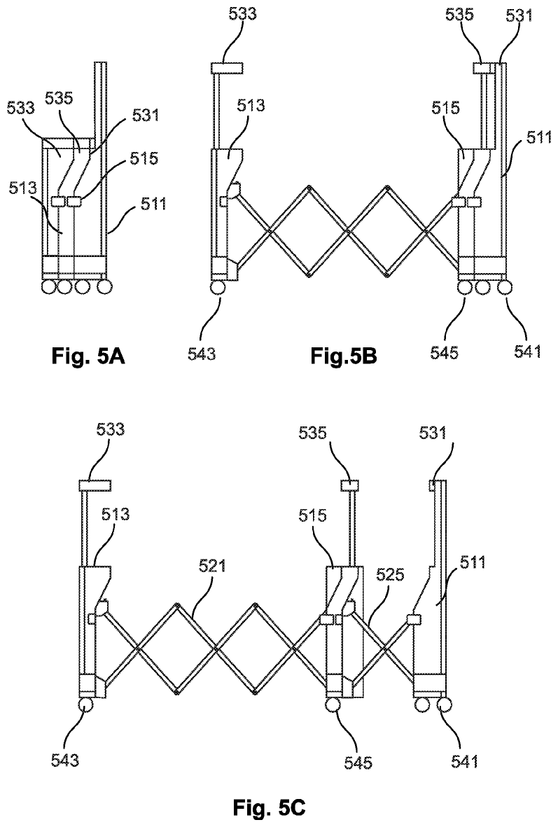

For example, in the arrangement of FIGS. 5A to 5C, in which similar features to the previous example are denoted by reference numerals increased by 100, the anteroom frame member 515 is deeper, and includes sloped features that align with a corresponding sloped profile on a rear of the front frame member 511.

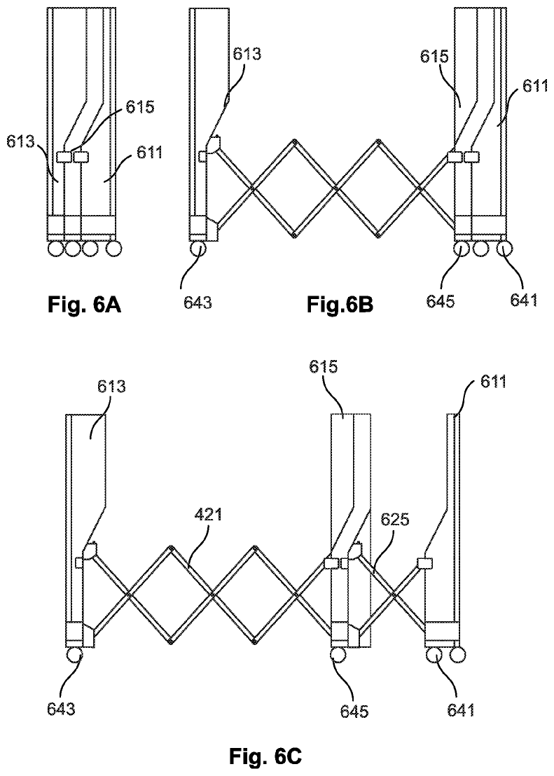

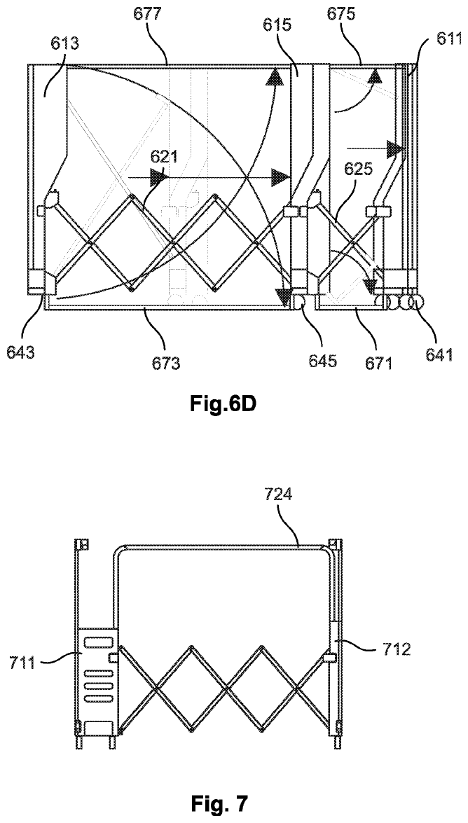

In the example of FIGS. 6A to 6C, in which similar features are again denoted by reference numerals increased by a further 100, the rear and anteroom frames members 613, 615 have a height similar to that of the front frame members 611.

It will be appreciated that this arrangement can provide additional support to the canopy mountings and additionally and/or alternatively, can be used to support canopy rails. In this regard, in the erected configuration, canopy rails are configured to extend between frame members to engage the canopy, for example to support the canopy roof and/or to bias the canopy wall edges against the floor, to thereby at least partially seal the canopy.

For example, the canopy rails can support the canopy in an elevated position using canopy rails that extend between upper ends of the rear frame members, upper ends of the first front and first rear frame members, upper ends of the second front and second rear frame members, upper ends the first front and first anteroom frame members, upper ends the second front and second anteroom frame members, upper ends the first anteroom and first rear frame members or upper ends the second anteroom and second rear frame members, depending on the frame configuration.

In this example, canopy rails 677, 675 are provided that are pivotally attached proximate upper ends of the rear and anteroom frame members 613, 615, allowing these to be deployed so that they extend between upper ends of the rear and anteroom frame members 613, 615 and the anteroom and front frame members 615, 611. Thereby supporting the side wall and roof of the interval volume and anteroom respectively. It will be appreciated that these could be deployed in a manner similar to that described above with respect to the curtain rail, for example employing a sliding mounting, allowing the canopy rails to be lifted into position as the frame is deployed. It will be appreciated that alternatively, the canopy rails could be removable, and may for example be attached to the frame members when the frame is in the collapsed configuration, with the rails being removed and reattached in an operative position, when the frame is erected. Similar canopy rails can also be provided extending between the rear frame members, to support the rear wall of the canopy.

Similarly, the canopy rails can bias the canopy against a floor using canopy rails that extend between lower ends of the rear frame members, lower ends of the first front and first rear frame members, lower ends of the second front and second rear frame members, lower ends the first front and first anteroom frame members, lower ends the second front and second anteroom frame members, lower ends the first anteroom and first rear frame members or lower ends the second anteroom and second rear frame members, depending on the frame configuration.

Thus, for example, in this instance, the canopy rails 673, 671 are provided that are pivotally attached proximate lower ends of the rear and anteroom frame members 613, 615, allowing these to be deployed so that they extend between lower ends of the rear and anteroom frame members 613, 615 and the anteroom and front frame members 615, 611. Thereby biasing the side walls of the internal volume and anteroom against the floor, which can assist in partially sealing the internal value and/or anteroom, to help maintain a negative pressure. Again, it will be appreciated that these could be deployed in a manner similar to that described above with respect to the curtain rail, for example employing a sliding mounting, allowing the canopy rails to be lowered into position as the frame is deployed.

As will also be apparent, in the event that upper and lower canopy rails are provided, these can provide sufficient support to the frame to obviate the need for the scissor arms. Consequently, in this example, the canopy rails act as, and hence replace, deployable arms. It will also be appreciated that the examples of scissor arms throughout is not intended to be limiting and other deployable arms could be used.

In a further embodiment, a second air filtering system may be arranged in the anteroom and configured to urge air into and/or out of the internal volume of the anteroom through a filter. For example, the filter could be provided as part of the canopy of the anteroom, with the fan being mounted on the frame, for example on the anteroom frame member 411, 511, 611.

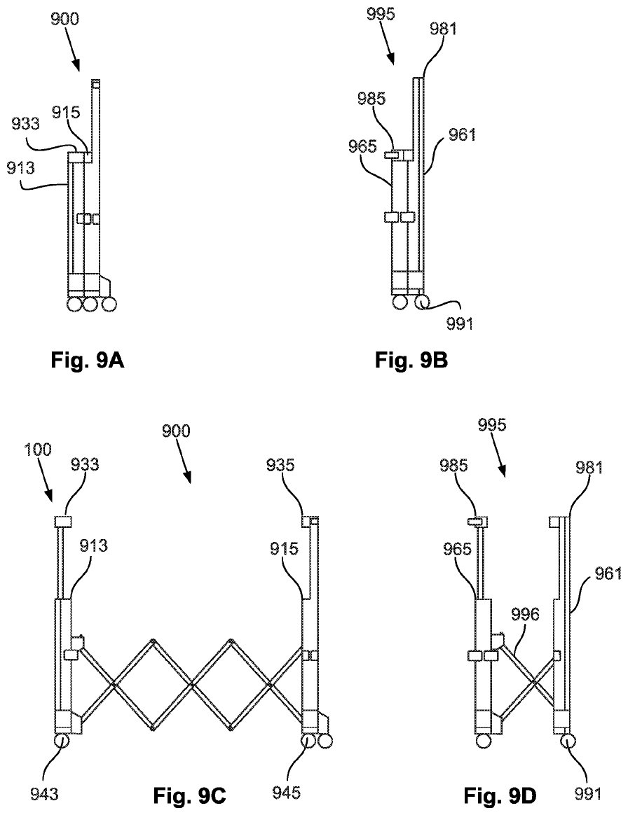

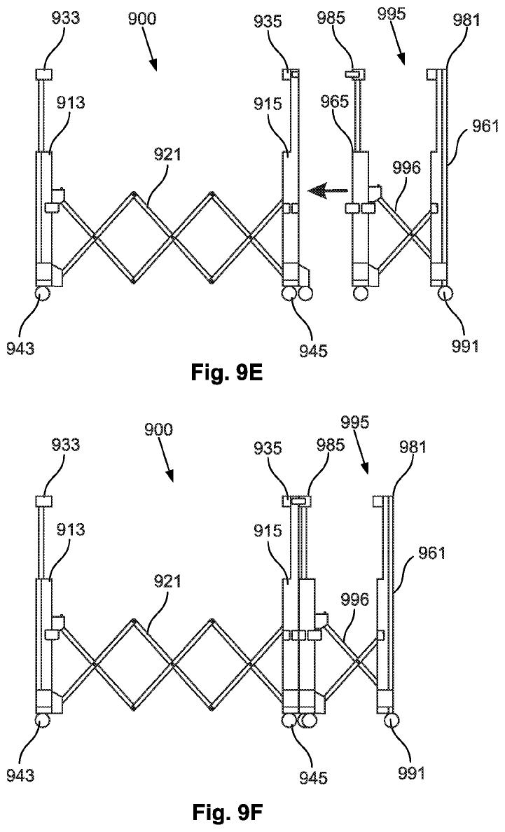

An example arrangement will now be described with reference to FIGS. 9A to 9F. In this example, similar features are denoted by similar reference numerals increased by 800 and these will not therefore be described in any detail. In this example, the anteroom 995 is provided as a separate structure to the frame 900 with a separate canopy that can be positioned adjacent to the entry of the frame 900.

The anteroom 995 includes first and second front frame members 961 and first and second rear frame members 965 with deployable arms 996 interconnecting the first front and first rear frame members 961, 965 the rear frame members and the second front and second rear frame members respectively. In this example, the deployable arms 996 are in the form of scissor arms, attached at each end to a respective frame member 961, 965.

The anteroom 995 includes canopy mountings 981, 985 movably mounted to each frame member 961, 965 with the anteroom canopy mountings being movable between lowered and elevated positions. In the lowered positions, this allows a canopy to be easily attached to the anteroom mountings, whilst in the raised position, the anteroom canopy is suspended at a height sufficient to provide head clearance for most individuals within the internal volume.

Optionally, the anteroom 995 may be attached or coupled to the frame 900 via a suitable connection as shown in FIGS. 9E and 9F.

A further example arrangement will now be described with reference to FIG. 7.

In this example, the frame includes front frame members 711, 712 having a reduced height compared to the frame members of the previous examples. In this instance, the curtain rail 724 is substantially U-shaped, and supported by the front frame members 711, 712, so that the curtain rail extends upwardly from the front frame members 711, 712, before spanning the doorway, allowing the curtains to be supported at an operative height. The curtain rail could be hingably mounted, but more typically is removable, allowing this to be positioned on the front frame members 711, 712, when the frame is otherwise erected. This avoids the need to including lifting mechanisms that lift the curtain rail, enabling the benefit of the lightweight arrangements to be obtained, whilst still enabling a curtain doorway to be provided.

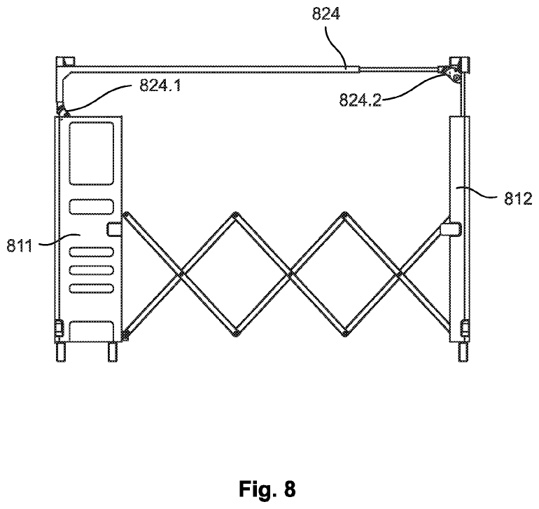

A further example arrangement will now be described with reference to FIG. 8.

In this example, the frame includes front frame members 811, 812 having a slightly reduced height compared to the frame members of FIGS. 1 to 6. In this instance, the curtain rail 824 is substantially L-shaped, and supported by the front frame members 811, 812, so that the curtain rail extends upwardly from the front frame members 811, before spanning the doorway, allowing the curtains to be supported at an operative height. The curtain rail could be hingably mounted to the first frame member 811 and slidably mounted to the second frame member 812 using a sliding mounting 824.2. In this instance, the second frame member 812 may extend slightly, to allow the curtain rail to be supported at a full height.

Whilst the above description has focused on isolating a patient having an infection, it will be appreciated that the system could also be used in other scenarios, for example to isolate immune deficient patients from surrounding patients, or the like. In one example, when isolating a patient to prevent the patient being exposed to potential infectious materials, the patient could be provided in the isolation apparatus. In a further example, this could be positively pressurised relative to the surrounding environment, thereby providing a hygienic environment within the enclosed space which excludes external contaminants e.g. for the purpose of conducting work or procedures, although it will be appreciated that pressurisation is not essential, and at least some isolation will be provided irrespective of whether pressurisation is used.

Whilst the above example has focused on use of the isolation apparatus in isolating a subject in the form of a patient, it will be appreciated that the above described arrangement can be used whenever any form of isolation is required. For example, the isolation apparatus could be used to provide a portable spray painting booth, which could be erected or positioned around an object or article to be painted, with the apparatus acting to support spray painting equipment when provided in the trolley configuration. In this instance, the apparatus is still used in isolating a subject, in the form of an object or article, preventing spray paint from impinging on the surrounding environment. Thus, it will be appreciated that the apparatus can be used in a wide range of circumstances and can be used for isolating any object or article, and that specific reference to patients as a preferred example, is not intended to be limiting.

Throughout the above description a number of features have been described in a single example. However, it will be appreciated that the different features could be used independently, and that their use in conjunction, whilst beneficial, is not necessarily essential.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

The term subject will be understood to apply to any entity that it is to be isolated and that this can include patients, as well as other individuals. The subject can also be a non-human subject such as an animal, including but not limited to, primates, livestock, performance animals, such as race horses, or the like. In addition to this, the isolation apparatus could also be used for equipment or other items, for example in case these have been exposed to contaminants. Thus, even when a patient is removed from the isolation apparatus, it will still continue to isolate any equipment contained therein, for example until this can be cleaned and/or disposed of. The term subject should therefore encompass any item and not be limited to a biological entity, even though it will be appreciated that the above described techniques are particularly advantageous for use with biological entities.

Persons skilled in the art will appreciate that numerous variations and modifications will become apparent. All such variations and modifications which become apparent to persons skilled in the art, should be considered to fall within the spirit and scope that the invention broadly appearing before described.

1) An isolation room apparatus configured to isolate a subject, the apparatus including:
a) a frame movable between collapsed and erected configurations, the frame including:
i) first and second front frame members;
ii) first and second rear frame members;
iii) deployable arms interconnecting:
(1) the first front and first rear frame members;
(2) the rear frame members; and,
(3) the second front and second rear frame members;
iv) a canopy mounting mounted to each frame member; and,
v) a curtain rail that in the erected configuration is mounted proximate upper ends of the first and second front frame members so that the curtain rail extends between the first and second front frame members above an opening defining a doorway; and,
b) a canopy configured to be supported by the frame in the erected configuration, the canopy defining an internal volume for containing a subject to thereby substantially isolate the subject from a surrounding environment and the canopy including one or more curtains supported by the rail to allow the curtains to be moved between open and closed positions to selectively provide access to the internal volume.

2) Apparatus according to claim 1, wherein the front frame members and curtain rail are configured so that the curtain rail is supported without requiring elevation or extension of the front frame members.

3) Apparatus according to claim 1, wherein the curtain rail is pivotally mounted proximate to an upper end of the first front frame member and configured to be mounted to an upper end of the second front frame member at a height sufficient to support the rail in an operative position.

4) Apparatus according to claim 3, wherein the curtain rail is slidably mounted to the second front frame member, so that the curtain rail raises as the frame is moved from the collapsed to the erected configuration.

5) Apparatus according to claim 1, wherein the curtain rail is configured to abut against the first front frame member when the frame is in the collapsed configuration.

6) Apparatus according to claim 1, wherein the curtain rail is stored removably mounted to the first front frame member when the frame is in the collapsed configuration and when the frame is in the erected configuration, the curtain rail is removably attached proximate upper ends of the first and second frame members.

7) Apparatus according to claim 1, wherein the curtain rail is extendible so that at least one of:
a) a width of the frame in the erected configuration is adjustable; and,
b) a width of the doorway is adjustable.

8) Apparatus according to claim 7, wherein apparatus is configured to be used with different sized canopies to provide isolation rooms have different widths.

9) Apparatus according to claim 1, wherein canopy mountings are at least one of:
a) movably mounted to each frame member, the canopy mountings being movable between lowered and elevated positions;
b) slidably mounted to a surface of the frame members;
c) supported by a shaft that can be raised relative to a frame member; and,
d) moved between lowered and elevated positions using linear actuators.

10) (canceled)

11) Apparatus according to claim 1, wherein the frame includes:
a) first and second anteroom frame members; and,
b) an anteroom curtain rail that in the erected configuration is mounted proximate upper ends of the first and second anteroom frame members so that the curtain rail extends between the first and second anteroom frame members above an opening defining a anteroom doorway, and wherein the canopy is configured to define a first internal volume configured to contain the subject and a second internal volume configured to define an anteroom.

12) Apparatus according to claim 1, wherein the frame includes:
a) first and second anteroom frame members; and,
b) extendable arms interconnecting:
i) the first front and first anteroom frame members;
ii) the second front and second anteroom frame members;
iii) the first anteroom and first rear frame members; and,
iv) the second anteroom and second rear frame members; and,
c) an anteroom curtain rail that in the erected configuration is mounted proximate upper ends of the first and second anteroom frame members so that the curtain rail extends between the first and second anteroom frame members above an opening defining a anteroom doorway, and wherein the canopy is configured to define a first internal volume between the rear and anteroom frame members for containing the subject and a second internal volume between the anteroom and front frame members defining an anteroom.

13) Apparatus according to claim 1, wherein the apparatus includes one or more canopy rails that in the erected configuration extend between frame members to engage the canopy and wherein at least one of:
a) the one or more canopy rails support the canopy in an elevated position and extend between at least one of:
i) upper ends of the rear frame members;
ii) upper ends of the first front and first rear frame members;
iii) upper ends of the second front and second rear frame members;
iv) upper ends of the first front and first anteroom frame members;
v) upper ends of the second front and second anteroom frame members;
vi) upper ends of the first anteroom and first rear frame members; and,
vii) upper ends of the second anteroom and second rear frame members; and,
b) the one or more canopy rails bias the canopy against a floor and extend between at least one of:
i) lower ends of the rear frame members;
ii) lower ends of the first front and first rear frame members;
iii) lower ends of the second front and second rear frame members;
iv) lower ends of the first front and first anteroom frame members;
v) lower ends of the second front and second anteroom frame members;
vi) lower ends of the first anteroom and first rear frame members; and,
vii) lower ends of the second anteroom and second rear frame members; and,
c) the deployable arms include the one or more canopy rails.

14.-16) (canceled)

17) Apparatus according to claim 1, wherein at least one of:
a) the apparatus includes:
i) a filter; and,
ii) a fan configured to urge air into and/or out of the internal volume through the filter;
b) the canopy is configured to at least partially seal to a floor; and,
c) the apparatus includes an air pump configured to pump air out of the internal volume so that the internal volume is at least partially negatively pressurized.

18-19) (canceled)

20) Apparatus according to claim 1, wherein at least one of:
a) the collapsed configuration the frame has a maximum height that is at least one of:
i. greater than 1400 mm;
ii. greater than 1500 mm;
iii. greater than 1600 mm;
iv. greater than 1750 mm;
v. less than 2100 mm;
vi. less than 2000 mm;
vii. less than a standard doorway opening; and,
viii. about 1895 mm; and,
b) without extension, the front frame members reach a height that is at least one of:
i) greater than 1400 mm;
ii) greater than 1500 mm;
iii) greater than 1600 mm;
iv) greater than 1750 mm;
v) less than 2100 mm;
vi) less than 2000 mm;
vii) less than a standard doorway opening; and,
viii) about 1895 mm.

21) (canceled)

22) Apparatus according to claim 1, wherein the apparatus includes a controller that is configured to control at least one of:
a) extension of the curtain rail;
b) extension of the extendable arms;
c) operation of a filter fan; and,
d) operation of an air pump.

23) Apparatus according to claim 22, wherein the apparatus includes a sensor configured to sense a canopy size, and wherein the controller is configured to control extension of the curtain rail and one or more extendable arms in accordance with a sensed canopy size.

24) Apparatus according to claim 23, wherein the canopy includes coded data indicative of the canopy size and the sensor is configured to sense the coded data provided on the canopy.

25) Apparatus according to claim 1, wherein the apparatus includes an actuator for at least one of opening and closing curtains supported by the curtain rail.

26) Apparatus according to claim 25, wherein at least one of:
a) the actuator includes at least one of:
i) a foot pedal;
ii) a foot pedal physically connected to the curtains; and,
iii) a controller that is configured to control the actuator;
b) the apparatus includes:
i) a sensor configured to sense an individual; and,
ii) a controller configured to control the actuator based on signals from the sensor; and,
c) the apparatus includes sensor configured to sense an individual and wherein the sensor at least one of:
i) is configured to sense an individual attempting to enter or exit the internal volume;
ii) is configured to sense an individual attempting to open or close the curtain; and,
iii) includes an RFID sensor configured to detect a tag associated with the individual.

27-28) (canceled)

29) Apparatus according to claim 1, wherein the frame may be detacheably coupled to an anteroom frame, wherein the anteroom frame includes:
a) a frame movable between collapsed and erected configurations, the frame including:
i) first and second front anteroom frame members;
ii) first and second rear anteroom frame members;
iii) deployable arms interconnecting:
(1) the first front and first rear anteroom frame members;
(2) the rear anteroom frame members; and,
(3) the second front and second rear anteroom frame members;
b) an anteroom canopy mounting mounted to each anteroom frame member; and,
c) an anteroom curtain rail that in the erected configuration is mounted proximate upper ends of the first and second anteroom front frame members so that the curtain rail extends between the first and second front anteroom frame members above an opening defining a doorway; and,
d) an anteroom canopy configured to be supported by the anteroom frame in the erected configuration, the anteroom canopy defining an internal volume.
